(19) United States
(12) Patent Application Publication
(10) Pub. No.: US 2014/0174785 A1
(43) Pub. Date: Jun. 26, 2014

(54) ROV CABLE INSULATION SYSTEM

(71) Applicant: NEXANS, Paris (FR)

(72) Inventors: Andreas Gabrielsen, Oslo (NO); Lars Oyvind Moen, Namsos (NO)

(21) Appl. No.: 14/066,766

(22) Filed: Oct. 30, 2013

(30) Foreign Application Priority Data
Dec. 21, 2012 (NO) NO 20121547

(51) Int. Cl. H01B 7/17

(52) U.S. Cl. CPC H01B 7/17
USPC 174/102 SC

(57) ABSTRACT

A ROV cable insulation system is provided having insulated electric conductors, sheathed drain wires, screen tape, and outer protection. The screen tape includes a polymeric semiconductive tape.

### PRIORITY CLAIM

This application claims priority to Norwegian Patent Application No. 2012 1547, filed on Dec. 21, 2012, the entirety of which is incorporated by reference.

### BACKGROUND

1. Field of the Invention

The invention relates to an ROV cable with improved electrical durability compared to prior art.

2. Description of Related Art

Conventional ROV cables used today have functioned relatively well, however with a constrained electrical lifetime, due to dimensional constraints that make it difficult and even impossible to apply any safety margins in the cable design. Such cables are typically used in conjunction with Remote Operated Vehicles (ROVs) being deployed from Tether Management Systems (TMSs), or directly from the surface.

Electrical failure of ROV cables may cause downtime for the operator, re-termination and in worst case abortion of the mission and sail to harbour for a replacement umbilical. Operational downtime is a key parameter for ROV operators, due to its effect on total operational cost.

The cable core consisting of multiple insulated electrical copper conductors are conventionally screened by interstitial drain wires electrical short-circuited by a collective metallic tape encapsulating the cable core. Screening is important to prevent hazard to equipment and personnel and to avoid corrosion of the steel wire armouring. The tape conventionally used is a two component tape with one metallic layer (typically Copper or Aluminium) and one polymeric side. The problem with such metallic tapes is that they tend to crack, due to the extensive amount of bend cycles such a cable experiences in operation. By cracking, the tape may lose its function of connecting the drain wires electrically, and in addition introduce metallic islands (isolated metallic tape sections not connected to ground potential).

U.S. Pat. No. 5,132,491 describes a coaxial cable having an insulated centre conductor and drain wires helically wrapped with two layers of a polymer tape, which has on one side a metal coat and on the other side a semiconductive adhesive polymer film layer. The polymer tape may be any polymer tape material known to be useful for wrapping around insulated signal conductors of coaxial signal cables. It is usually a thermoplastic polymer, but may be PTFE, and is preferably a polyester tape. The tape may be metal-coated in any customary way with an electrically conductive metal, aluminium being preferred. On the reverse side of tape is affixed a semiconductive polymer film, usually a conductive carbon-filled polyester adhesive tape. Other materials could be used to achieve a thinner more flexible coating. The object of the invention is to provide a ROV cable which improves the electrical durability of prior art cables.

### OBJECTS AND SUMMARY OF THE INVENTION

The object of the invention is achieved by means of the features of the patent claims.

In one embodiment, a ROV cable according to the invention comprises insulated electric conductors, drain wires, collective screen tape, and protection, wherein the screen tape comprises a polymeric semi-conductive tape.

The insulated electrical conductors are the conductive elements of the cable, and will transfer electric power or signals. Power conductors can be of varying sizes with voltage rating up to 6.6 kV. The power conductor cores have a dual polymer insulation design, the inner part is semi-conductive and the outer part is an insulator.

The drain wires are electrical conductors (e.g. Cu) which are sheathed with semi-conductive polymer. The collective screen tape short-circuits all drain wires, so that any fault current are equally distributed among the drain wires. The screen tape also confines the dielectrical field within the cable.

The term semi-conductive will in this context mean a volume resistivity<1000Ωm. The polymeric semiconductive tape is made of a material that is more elastic and fatigue resistive than metal and less prone to fatigue failure during bending. In one embodiment, the polymeric semiconductive tape is a semiconductive nylon tape.

In other embodiments, the polymeric semi-conductive tape is made of polyamide, or polyamide and an adhesive. In the latter case, the adhesive may provide the desired conductivity to achieve the semi-conducting properties.

The screen tape wrapping/outer protection may comprise one or several layers.

### BRIEF DESCRIPTION OF THE DRAWINGS

The invention will now be described in more detail, by means of an example and with reference to the accompanying drawings.

FIG. 1 shows schematically the structure and composition of a ROV cable according to the invention.

### DETAILED DESCRIPTION

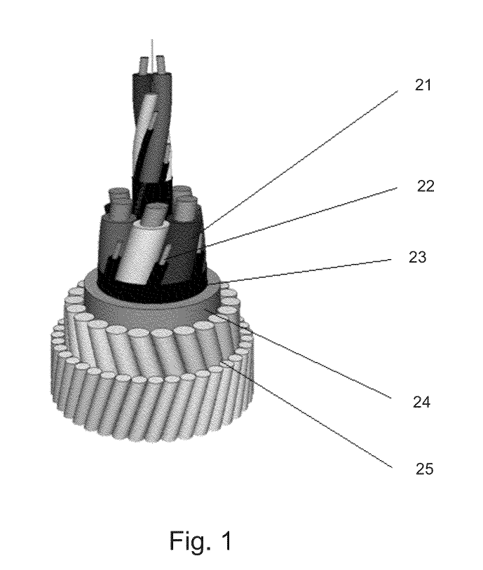

In FIG. 1 it is illustrated the structure and composition of a ROV cable. In this example the cable comprises insulated electric conductors 21 for transferring power, for example Cu wires with an insulating polypropylene sheathing according to Nexans' dual insulation technology. Outside the power conductors 21, there are arranged drain wires 22, sheathed with semi-conductive polymer (i.e. polypropylene). A polymeric semiconductive screen tape 23 is further arranged outside the drain wires 22, making contact with the drain wires 22. The screen tape is in electrical contact with the drain wires. For example the semiconductive screen tape may be nylon tape with longitudinal tensile strength>110 N/cm, transverse tensile strength>60 N/cm, longitudinal elongation>25%, and transverse elongation>20%, or nylon 66 with longitudinal tensile strength>200 N/cm, transverse tensile strength>140 N/cm, longitudinal elongation>25%, and transverse elongation>20%.

An outer protection comprises in this embodiment a cable core sheathing 24 with high durability, for example made of thermoplastic polyester and a torque balanced steel wire armouring comprising contra-helical layers for protection. Experiments have shown that the use of semiconductive polymeric screen tape, in conjunction with Nexans already developed dual polypropylene insulation system, will heighten the onset level of partial discharge activity and heighten the breakdown voltage of the conductors, and thereby prolong the electrical lifetime. A semiconductive polymer tape (e.g. nylon) has the following advantages in comparison with a two-component metallic tape:
1. It will not crack during bending and will therefore provide a more stable and long lasting function of electrically short-circuiting the drain wires.
2. Since it will not crack isolated islands at arbitrary voltage potential will not develop.
3. A polymer tape is more elastic than a metallic tape and will not attain the same large curvature locally as the metallic tapes when applied to the cable core. The larger the curvature is, the more will the electrical field be enhanced at that spot, which will lead to reduced lifetime.
4. A polymer tape is easier to apply during manufacturing and will reduce the risk of tape damages. A tape which is torn will enhance the electrical field at that location and reduce electrical lifetime.

1. ROV cable insulation system comprising:
insulated electric conductors;
sheathed drain wires;
screen tape; and
outer protection, wherein the screen tape has a polymeric semiconductive tape.

2. ROV cable according to claim 1, where the polymeric semiconductive tape is a semiconductive nylon tape.

3. ROV cable according to claim 1, where the polymeric semiconductive tape has a volume resistivity better than 1000Ωm.

4. ROV cable according to claim 1, where the polymeric semiconductive tape is made of polyamide.

5. ROV cable according to claim 1, where the polymeric semiconductive tape is made of polyamide and an adhesive.

6. ROV cable according to claim 1, where the power conductor insulation includes an inner semi-conductive part and an outer insulator part.

7. ROV cable according claim 1, where the drain wires are sheathed with semi-conductive polymer.
